(19) United States
(12) Patent Application Publication
(10) Pub. No.: US 2003/0106590 A1
(43) Pub. Date: Jun. 12, 2003

(54) Airless paint pump inlet spring

(76) Inventors: David J. Thompson, Oak Grove, MN (US); Benjamin J. Hitter, Monticello, MN (US); Jerry D. Horning, Coon Rapids, MN (US)

Correspondence Address: Graco Minnesota Inc., P. O. Box 1441, Minneapolis, MN, 55440-1441, US

(21) Appl. No.: 10/166,343

(22) Filed: Sep. 25, 2001

(51) Int. Cl. F16K 15/04

(52) U.S. Cl. 137/535

(57) ABSTRACT

A spring is provided for a paint pump inlet check valve. The spring is a simple stamped, laser cut or coiled cantilever or flat spiral extension spring with a small bumper. The design of the spring serves to enhance priming of the pump yet prevents the spring from packing out with solids in the paint or other material being pumped.

### RELATED APPLICATIONS

This application is a ______ of U.S. application Ser. No. ______, filed ______.

### BACKGROUND OF THE INVENTION

Airless paint spray pumps have been well-known and used for many years. Such pumps typically have an inlet check valve. Such pumps with inlet check valves often have springs which help the trackball to seat. While such springs are generally effective, they suffer from the problem of often packing out, that is, solids in the paint become packed between the coils of the spring such that the spring locks up and no longer allows movement of the check ball.

### SUMMARY OF THE INVENTION

The primary design advantage this design has over a standard compression spring is that is will not pack out. In addition, it will not limit ball travel with current designs (retrofitable). It accomplishes the ball loading in a smaller shorter package than a compression spring. It is less restrictive to the fluid flow paths which improves efficiency, decreases priming time and makes priming consistent. It allows the ball to spin giving the ball it's expected life. Lastly, a hard contact pin contacts the ball instead of the spring, which increases life. The material can range from medium to high carbon spring steels (1050-1095), or some classes of stainless steel. The part is a simple stamped, laser cut, or coiled cantilever or flat spiral extension spring with a small bumper (contact pin) that is assembled afterward.

By applying a load (specific per pump size) to the top of the inlet ball check valve, it speeds the seating of the ball on the closing stroke. This increases efficiency due in part to less material (air or fluid) losses out of the main pump chamber. In addition, the ball is very directly placed back on the seating area and held firmly negating any outside noise or vibration.

These and other objects and advantages of the invention will appear more fully from the following description made in conjunction with the accompanying drawings wherein like reference characters refer to the same or similar parts throughout the several views.

### A BRIEF DESCRIPTION OF THE DRAWINGS

FIG. 1 is a cross-section of the check valve of the preferred embodiment of the instant invention.

FIG. 2a is a cross-section of the check valve of an alternate embodiment of the instant invention in the closed position.

FIG. 2b is a cross-section of the check valve of an alternate embodiment of the instant invention in the open position.

FIG. 3 shows the check valve of the instant invention in a reciprocating piston pump.

FIG. 4 shows a plan view of the spring of the preferred embodiment.

FIG. 5 shows a plan view of the spring of the alternate embodiment.

### DESCRIPTION OF THE PREFERRED EMBODIMENT

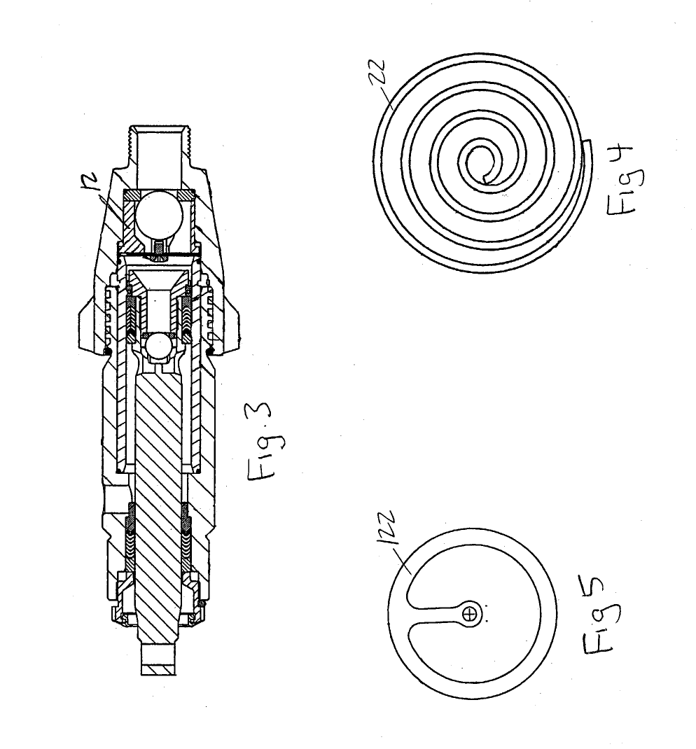

The preferred embodiment (generally 10) of the instant invention is shown in FIGS. 1, 3 and 4. In particular, check valve 12 has a check ball 14 constrained by a housing 16 and a seat 18. An inlet spring assembly 20 is comprised of a spiral spring 22, a contact pin 24 and a screw 26 or other fastener (adhesive, rivet, etc.). The spring 22 is formed of 0.0625 inch diameter 17-7 stainless steel heat treated to H 900 condition. The screw 26 is fastened to contact pin 24 with a high strength thread locking compound.

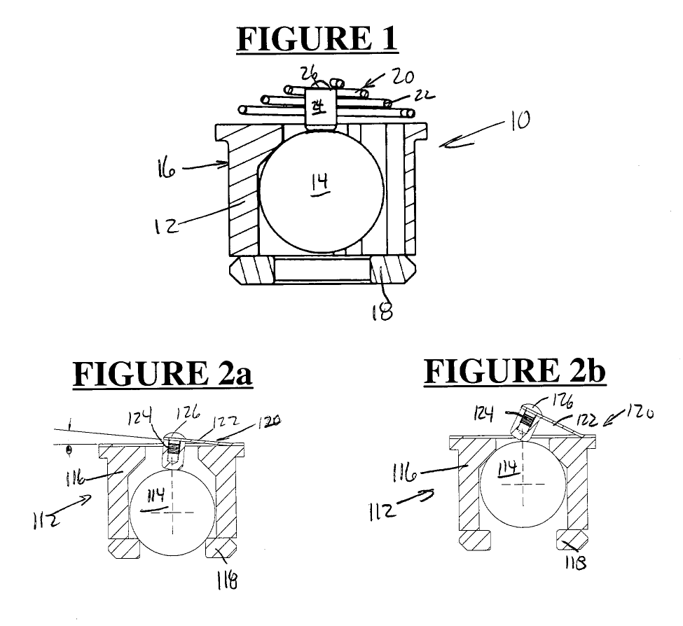

An alternate embodiment is shown in FIGS. 2a and 2b, 3 and 5. In particular, check valve 112 has a check ball 114 constrained by a housing 116 and a seat 118. An inlet spring assembly 120 is comprised of a spring 122, a contact pin 124 and a screw 126 or other fastener (adhesive, rivet, etc.). The spring 122 is formed of AIS 1075 cold rolled annealed spring steel heat treated to 50 RC. The screw 126 is fastened to contact pin 124 with a high strength thread locking compound.

It is contemplated that various changes and modifications may be made to the pump inlet spring without departing from the spirit and scope of the invention as defined by the following claims.

What is claimed is:

1. In a reciprocating piston pump for pumping solids containing materials, said pump having an inlet check valve with a check ball, the improvement comprising a spring located in said check valve, said spring being substantially two dimensional when in a relaxed state.
